(19) United States
(12) Patent Application Publication
(10) Pub. No.: US 2025/0347569 A1
(43) Pub. Date: Nov. 13, 2025

(54) ALLOY FOR STRAIN RESISTORS, STRAIN GAUGE, AND SENSOR

(71) Applicant: Alps Alpine Co., Ltd., Tokyo (JP)

(72) Inventors: Yosuke IDE, Niigata-ken (JP); Masakazu SERA, Niigata-ken (JP); Mitsuji YANO, Niigata-ken (JP); Hiroko SHINOZAKI, Niigata-ken (JP)

(21) Appl. No.: 19/277,938

(22) Filed: Jul. 23, 2025

Related U.S. Application Data
(63) Continuation of application No. PCT/JP2024/000414, filed on Jan. 11, 2024.

(30) Foreign Application Priority Data
Feb. 16, 2023 (JP) 2023-022826

(51) Int. Cl. G01L 1/22; C22C 27/06

(52) U.S. Cl. CPC G01L 1/2287; C22C 27/06

(57) ABSTRACT

A strain gauge includes a film-shaped strain resistor having an alloy composition of Cr_{100-x-y}FeₓM_{y}, where the element M is one or two or more selected from the group consisting of Nb, Mo, Ta, and W, x representing the ratio of Fe added may be preferably 0.8 or more and 11.2 or less in terms of atomic percentage, and y representing the ratio of M added may be preferably more than 0 and less than or equal to 7.7 in terms of atomic percentage.

### CLAIM OF PRIORITY

This application is a Continuation of International Application No. PCT/JP2024/000414 filed on Jan. 11, 2024, which claims benefit of Japanese Patent Application No. 2023-022826 filed on Feb. 16, 2023. The entire contents of each application noted above are hereby incorporated by reference.

### BACKGROUND OF THE INVENTION

### 1. Field of the Invention

The present invention relates to an alloy for strain resistors, a strain gauge, and a sensor.

### 2. Description of the Related Art

Strain gauges are known that are affixed to an object to be measured (strain generating body) to detect strain of the object. Examples of a constituent material of the strain gauge include a strain resistor which changes in resistance as the strain resistor deforms in response to an external force; specifically, the examples include metal materials containing Ni, Cr, Cu, and the like. The strain resistor is formed, for example, in the shape of a film on a substrate, and then treated to have a desired pattern such as a meandering pattern, by a photolithography technique and an etching technique, or the like.

In view of the fact that the strain resistor has a large absolute value of the temperature coefficient of resistance in many cases, Japanese Unexamined Patent Application Publication No. 2019-204874, for example, proposes a thin-film resistor for strain gauges which exhibits a gauge factor of 10 or more and a temperature coefficient of resistance of ±100 [ppm/° C.] or less, as one example of a resistor for strain gauges. The thin-film resistor contains chromium (Cr), oxygen (O), and nitrogen (N), and is represented by a general formula Cr100-x-yOxNy, where the composition ratios x and y satisfy a relationship of 3.0≤x≤15.0 and a relationship of 1.0≤y≤10.0 in terms of atomic percentage, and the chromium has a (110)-oriented body-centered cubic (BCC) structure.

According to the thin-film resistor described in Japanese Unexamined Patent Application Publication No. 2019-204874, the orientation of chromium is controlled by optimization of a heat treatment included in the production steps, thereby reducing the temperature coefficient of resistance TCR. This means that variations in the production steps readily affect the temperature coefficient of resistance TCR of the thin-film resistor according to Japanese Unexamined Patent Application Publication No. 2019-204874. Accordingly, it is not easy to stably produce strain resistors which exhibit a high gauge factor Gf and are not readily affected by temperature changes by the method described in Japanese Unexamined Patent Application Publication No. 2019-204874.

### SUMMARY OF THE INVENTION

In view of the above circumstances, the present invention provides a strain gauge which exhibits a high gauge factor Gf and is not readily affected by temperature changes through a different approach from that described in Japanese Unexamined Patent Application Publication No. 2019-204874, and the present invention makes it easy to form a strain resistor to be provided in the strain gauge with use of a general-purpose sputtering apparatus or the like, since the necessity of reactive gas components such as oxygen and nitrogen in the production process is eliminated. The present invention further provides an alloy for strain resistors which gives the strain resistor to be provided in the strain gauge, and a sensor including the strain gauge.

An alloy for strain resistors according to one aspect of the present invention for solving the problem mentioned above has a composition of Cr_{100-x-y}FeₓM_{y}, where M represents one or two or more elements selected from the group consisting of Nb, Mo, Ta, and W (hereinafter may be referred to as “element M”).

A Cr—Fe alloy can give a strain resistor having a gauge factor Gf of 10 or more and a negative temperature coefficient of resistance TCR. On the other hand, a Cr-M alloy can give a strain resistor having a gauge factor Gf or 10 or more and a positive temperature coefficient of resistance TCR. Consequently, a gauge factor Gf of 10 or more and a temperature coefficient of resistance TCR falling within a range of +1000 ppm/° C. can be readily achieved by a strain resistor composed of the alloy for strain resistors having a composition of Cr_{100-x-y}FeₓM_{y}, which is an alloy composed of the above-mentioned components.

Furthermore, since the gauge factor Gf and the temperature coefficient of resistance TCR can be controlled through the composition of the alloy, the crystal structure does not need to be precisely controlled as compared to the case disclosed in Japanese Unexamined Patent Application Publication No. 2019-204874 where oxygen (O) and nitrogen (N) are contained together with Cr. Accordingly, the strain resistor can be easily produced with use of a general-purpose sputtering apparatus or the like. Therefore, with use of the above-described alloy for strain resistors, a strain resistor which exhibits a high gauge factor Gf and is not readily affected by the temperature can be obtained without increase in production load and therefore at high quality.

In the above-described alloy for strain resistors, x representing the amount of Fe added may be preferably 0.8 or more and 11.2 or less in terms of atomic percentage. In addition, y representing the amount of the element M added may be preferably more than 0 and less than or equal to 7.7 in terms of atomic percentage. With the above conditions satisfied, a strain resistor which exhibits a high gauge factor Gf and is not readily affected by the temperature can be obtained more stably at high quality.

A strain gauge according to another aspect of the present invention includes a film-shaped strain resistor having the composition of the above-described alloy for strain resistors. The strain gauge exhibits a high gauge factor Gf and is not readily affected by temperature changes. The film-shaped strain resistor may be composed of a thin film formed by a film-forming process such as sputtering, or foil formed by machining such as rolling. That is, the concept of “film-shaped” includes the shape of a thin film and the shape of foil. The strain resistor of the strain gauge preferably has a BCC structure from the viewpoint of stably achieving a high gauge factor Gf.

The strain gauge preferably has a gauge factor Gf and an absolute value |TCR| of a temperature coefficient of resistance TCR (unit: ppm/° C.) satisfying the following expression (1) or (2):

$$G f > 0.0 \; 056 \times \vert TCR \vert + 10.21 \qquad ( 1 )$$

$$Gf \geq 0.0 \; 056 \times \vert TCR \vert + 11 \qquad ( 2 )$$

A sensor according to another aspect of the present invention includes a substrate and the above-described strain gauge provided on the substrate, in which the strain gauge serves as sensing means.

### BRIEF DESCRIPTION OF THE DRAWINGS

FIG. 1 is a diagram illustrating one example of a strain sensor according to one embodiment of the present invention;

FIG. 2 is a schematic diagram illustrating a cross-section taken along line II-II in FIG. 1;

FIG. 3 is a graph representing the relationship between the gauge factor Gf of a strain gauge including a strain resistor composed of a Cr—X alloy and the amount of an element X added;

FIG. 4 is a graph representing the relationship between the temperature coefficient of resistance TCR of the strain gauge including the strain resistor composed of the Cr—X alloy and the amount of the element X added;

FIG. 5 is a graph representing the relationship between the gauge factor Gf and the temperature coefficient of resistance TCR of the strain gauge including the strain resistor composed of the Cr—X alloy;

FIG. 6 is a graph converted from that of FIG. 5 so that the horizontal axis shows the absolute value of the temperature coefficient of resistance TCR;

FIG. 7 is a graph showing the results of Examples 1 and 2 (influence of change in composition of a Cr—Fe—Ta alloy), representing the dependency of the gauge factor Gf on the amount of Ta added;

FIG. 8 is a graph showing the results of Examples 1 and 2 (influence of change in composition of the Cr—Fe—Ta alloy), representing the dependency of the temperature coefficient of resistance TCR on the amount of Ta added;

FIG. 9 is a graph showing the results of Example 3 (changes in film thickness), representing the dependency of the gauge factor Gf on the temperature coefficient of resistance TCR;

FIG. 10 is a graph showing the results of Examples 4 to 6 (types of M), representing the dependency of the gauge factor Gf on the amount of element M added;

FIG. 11 is a graph showing the results of Examples 4 to 6 (types of M), representing the dependency of the temperature coefficient of resistance TCR on the amount of element M added;

FIG. 12 is a graph showing the results of Examples 1 and 2 (influence of change in composition of the Cr—Fe—Ta alloy), representing the dependency of the gauge factor Gf on the absolute value of the temperature coefficient of resistance TCR; and

FIG. 13 is a graph showing the results of Examples 4 to 6 (types of M), representing the dependency of the gauge factor Gf on the absolute value of the temperature coefficient of resistance TCR.

### DESCRIPTION OF THE PREFERRED EMBODIMENTS

An embodiment of the present invention will be described below with reference to the drawings. Note that, in the following description, the same members are denoted by the same reference sign, and description of members which have already been described will be omitted as appropriate.

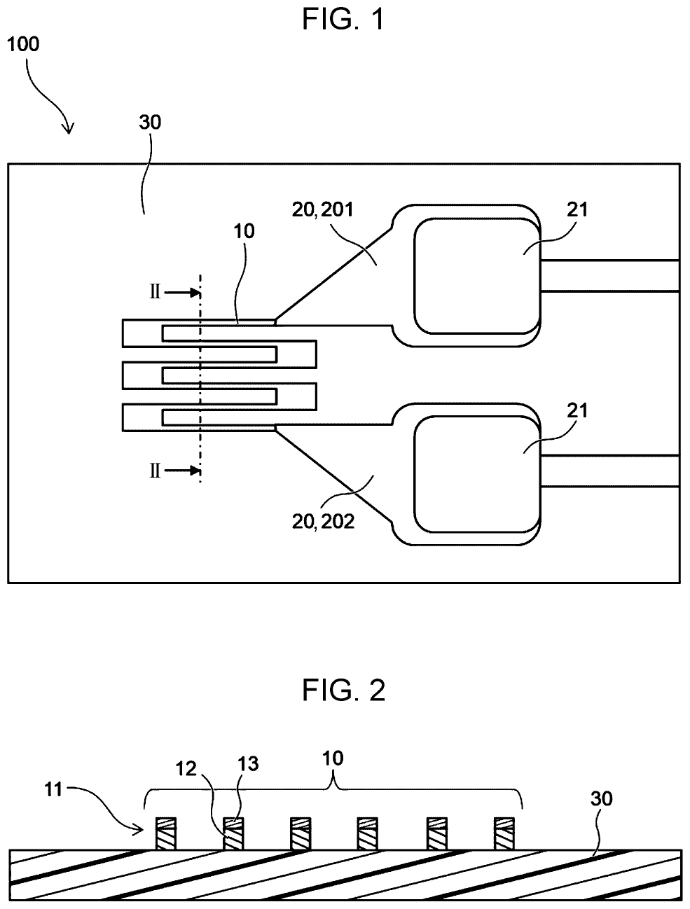

FIG. 1 is a diagram illustrating one example of a strain sensor according to one embodiment of the present invention. As illustrated in FIG. 1, a sensor 100 according to the embodiment includes a strain gauge 10 having a meandering pattern, and electrodes 20 for electrifying the strain gauge 10. Both of the strain gauge 10 and the electrodes 20 are formed on a substrate 30. The strain gauge 10 functions as sensing means. The sensor 100 may be a strain sensor for measuring the strain of the strain gauge 10 itself on the basis of signals from the strain gauge 10, a deformation/displacement sensor for measuring the degree of deformation of a member (strain generating body) on which the sensor 100 is attached, or a sensor for measuring other physical quantities (pressure, velocity, acceleration, and the like) on the basis of the degree of deformation of the strain generating body. Non-limiting examples of a constituent material of the electrodes 20 include Cu, Au, and alloys containing them. The electrodes 20 include a first electrode 201 connected to one end of the strain gauge 10, and a second electrode 202 connected to the other end thereof, and each of the first electrode 201 and the second electrode 202 is provided with a plating layer 21 for the purpose of increasing the solder bonding strength.

FIG. 2 is a schematic diagram illustrating a cross-section taken along line II-II in FIG. 1. As illustrated in FIG. 2, the strain gauge 10 includes a layered product 11 having a film-shaped strain resistor 12 and a protection layer 13 that has a portion being in contact with the strain resistor 12, and the layered product 11 has a form of a meandering pattern. The protection layer 13 is provided as necessary and is not essential, and may be composed of Ta, for example.

The strain resistor 12 has a property of changing in resistance value as its length changes in the direction of electrical flow in response to an external force. This property can be quantitatively evaluated in terms of the gauge factor Gf represented by the following expression (A):

$$G f = ( Δ R / R ) / ( Δ L / L ) \qquad ( A )$$

In the above expression, L represents the length in the direction of electrical flow (the length in the electrical flow direction) of the strain gauge 10 in the state where no external force is applied (with no load), ΔL represents the amount of change in the length in the electrical flow direction of the strain gauge 10 in the state where an external force is applied to the strain gauge 10 (with a load) relative to the state with no load, R represents the resistance value of the strain gauge 10 with no load, and ΔR represents the amount of change in the resistance value of the strain gauge 10 with a load relative to the state with no load.

In the embodiment, the strain resistor 12 is composed of a Cr—Fe-M alloy having a composition of Cr_{100-x-y}FeₓM_{y}, which serves as an alloy for strain resistors. M of the above composition is one or two or more elements selected from the group consisting of Nb, Mo, Ta, and W (element M). The crystal structure of the strain resistor 12 is preferably a BCC structure from the viewpoint of increasing the gauge factor Gf of the strain resistor 12. A non-limiting example of the specific electrical resistance of the strain resistor 12 is 100 μΩcm or less.

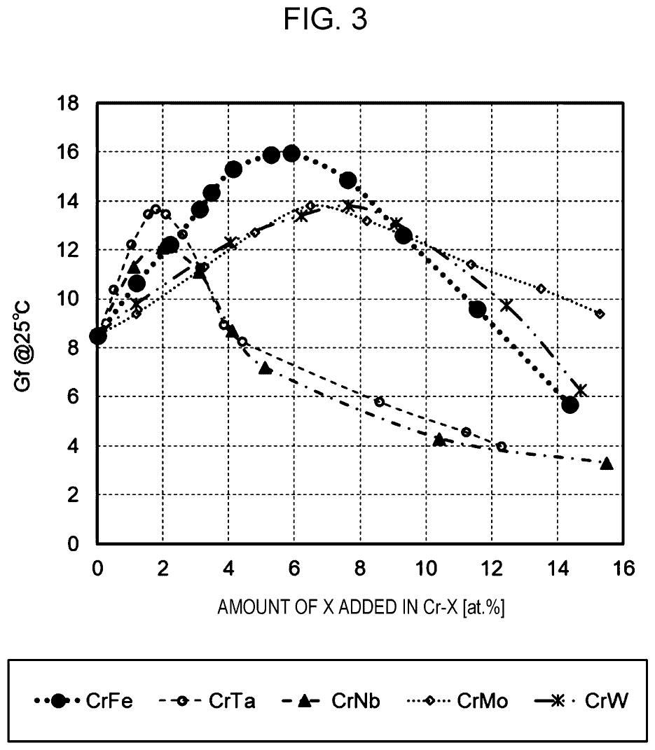

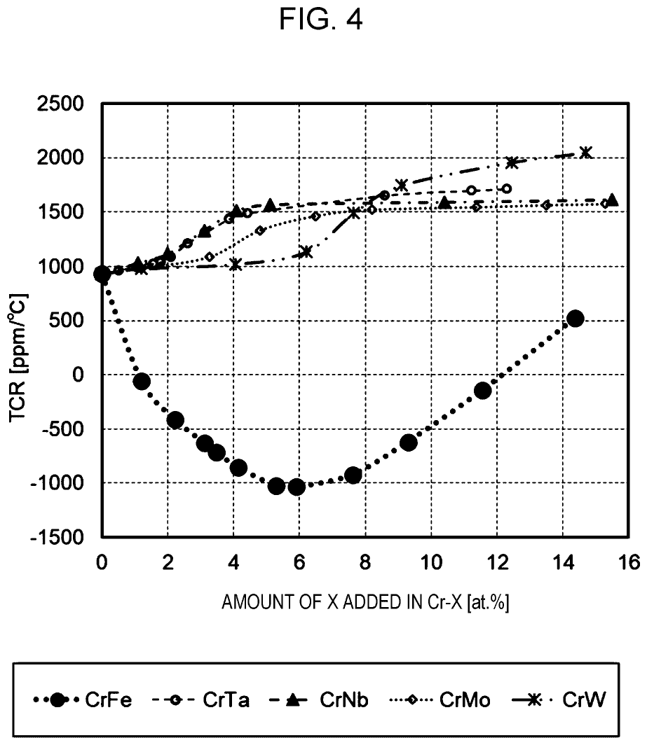

Table 1 shows the results of the measurement of the gauge factor Gf (measurement temperature was 25° C., the same applies hereinafter) and the temperature coefficient of resistance TCR of the strain gauges 10 including the strain resistors 12 composed of Cr—X alloys (element X was one of Fe, Ta, Nb, Mo, or W, the same applies hereinafter) with varying amounts of element X added. FIG. 3 is a graph generated from the results shown in Table 1, showing the relationship between the gauge factor Gf of the strain gauge 10 including the strain resistor 12 composed of the Cr—X alloy and the amount of the element X added. FIG. 4 is a graph generated from the results shown in Table 1, showing the relationship between the temperature coefficient of resistance TCR of the strain gauge 10 including the strain resistor 12 composed of the Cr—X alloy and the amount of the element X added.

TABLE 1

| CrFe | | | CrTa | | | CrNb | | | CrMo | | | CrW | | |
|---|---|---|---|---|---|---|---|---|---|---|---|---|---|---|
| Amount | | | Amount | | | Amount | | | Amount | | | Amount | | |
| of Fe | | TCR | of Ta | | TCR | of Nb | | TCR | of Mo | | TCR | of W | | TCR |
| added | | [ppm/ | added | | [ppm/ | added | | [ppm/ | added | | [ppm/ | added | | [ppm/ |
| [at. %] | Gf | ° C.] | [at. %] | Gf | ° C.] | [at. %] | Gf | ° C.] | [at. %] | Gf | ° C.] | [at. %] | Gf | ° C.] |
| 0.0 | 8.5 | 930 | 0.0 | 8.5 | 930 | 0.0 | 8.5 | 930 | 0.0 | 8.5 | 930 | 0.0 | 8.5 | 930 |
| 1.2 | 10.7 | −54 | 0.5 | 10.4 | 957 | 1.1 | 11.3 | 1032 | 1.2 | 9.4 | 983 | 1.2 | 9.8 | 976 |
| 2.2 | 12.2 | −412 | 1.0 | 12.2 | 994 | 2.0 | 12.1 | 1115 | 3.3 | 11.3 | 1087 | 4.1 | 12.3 | 1020 |
| 3.1 | 13.7 | −629 | 1.6 | 13.5 | 1021 | 3.1 | 11.1 | 1329 | 4.8 | 12.7 | 1331 | 6.2 | 13.4 | 1132 |
| 3.5 | 14.3 | −714 | 1.8 | 13.6 | 1034 | 4.1 | 8.7 | 1515 | 6.5 | 13.8 | 1463 | 7.7 | 13.8 | 1489 |
| 4.1 | 15.3 | −854 | 2.1 | 13.5 | 1085 | 5.1 | 7.2 | 1568 | 8.2 | 13.2 | 1519 | 9.1 | 13.1 | 1743 |
| 5.3 | 15.9 | −1021 | 2.6 | 12.6 | 1208 | 10.4 | 4.3 | 1592 | 11.4 | 11.4 | 1543 | 12.5 | 9.7 | 1956 |
| 5.9 | 16.0 | −1034 | 3.1 | 11.3 | 1305 | 15.5 | 3.3 | 1613 | 13.5 | 10.4 | 1561 | 14.7 | 6.3 | 2045 |
| 7.6 | 14.9 | −921 | 3.9 | 8.9 | 1432 | | | | 15.3 | 9.4 | 1572 | | | |
| 9.3 | 12.6 | −618 | 4.4 | 8.2 | 1487 | | | | | | | | | |
| 11.6 | 9.6 | −143 | 8.6 | 5.8 | 1651 | | | | | | | | | |
| 14.4 | 5.7 | 521 | 11.2 | 4.5 | 1697 | | | | | | | | | |
| | | | 12.3 | 4.0 | 1710 | | | | | | | | | |

As shown in FIGS. 3 and 4, the Cr—Fe alloy can give the strain gauge 10 exhibiting a gauge factor Gf of 10 or more and a negative temperature coefficient of resistance TCR. On the other hand, the Cr—X alloys other than the Cr—Fe alloy can give the strain gauge 10 exhibiting a gauge factor Gf of 10 or more and a positive temperature coefficient of resistance TCR. Consequently, the strain gauge 10 including the strain resistor 12 composed of an alloy for strain resistors having a composition of Cr_{100-x-y}FeₓM_{y}, which is an alloy composed of the above-mentioned components, can readily achieve a gauge factor Gf of 10 or more and a temperature coefficient of resistance TCR falling within the range of ±1000 ppm/° C.

Furthermore, the gauge factor Gf and the temperature coefficient of resistance TCR of the strain gauge 10 can be controlled through the composition of the alloy composing the strain resistor 12, the crystal structure does not need to be precisely controlled as compared to the case disclosed in Japanese Unexamined Patent Application Publication No. 2019-204874 where oxygen (O) and nitrogen (N) are contained together with Cr. Therefore, the use of the above-described alloy for strain resistors does not increase the production load, and accordingly, the strain gauge 10 which exhibits a high gauge factor Gf and is not readily affected by the temperature can be obtained at high quality.

In the above-described alloy for strain resistors, x representing the amount of Fe added may be preferably 0.8 or more and 11.2 or less in terms of atomic percentage. Since the gauge factor Gf of the strain gauge 10 is 10 or more when the amount of Fe added (x) in the Cr—Fe alloy falls within a range of 0.8 at. % or more and 11.2 at. % or less as shown in FIG. 3, it is easy to allow the strain gauge 10 including the strain resistor 12 composed of the Cr—Fe-M alloy to exhibit a high gauge factor Gf and to be not readily affected by temperature changes, by setting the amount of Fe added (x) within such a range. From the viewpoint of more stably producing the strain gauge 10 which exhibits a high gauge factor Gf and is not readily affected by temperature changes, the amount of Fe added (x) may be preferably 1.2 at. % or more and 9.3 at. % or less, more preferably 3.1 at. % or more and 7.6 at. % or less.

In addition, y representing the amount of the element M added (the amount of M added) may be preferably more than 0 and less than or equal to 7.7 in terms of atomic percentage. When the amount of M added (y) falls within the above range, the gauge factor Gf of some of the elements serving as the element M tends to increase as shown in FIG. 3 while the temperature coefficient of resistance TCR takes a positive value, and therefore, it is easy to produce the strain resistor 12 which exhibits a high gauge factor Gf and is not readily affected by temperature changes. From the viewpoint of more stably producing the strain resistor 12 which exhibits a high gauge factor Gf and is not readily affected by temperature changes, the amount of M added (y) may be preferably 0.5 at. % or more and 3.5 at. % or less, more preferably 1.1 at. % or more and 3.1 at. % or less, particularly preferably 1.1 at. % or more and 2.1 at. % or less, in the case where the element M is composed of Ta.

From the same viewpoint, the amount of M added (y) may be preferably 0.5 at. % or more and 3.5 at. % or less, more preferably 0.5 at. % or more and 3.1 at. % or less, particularly preferably 1.1 at. % or more and 2.0 at. % or less, in the case where the element M is composed of Nb.

From the same viewpoint, the amount of M added (y) may be preferably 2 at. % or more and 14 at. % or less, more preferably 3.3 at. % or more and 13.5 at. % or less, particularly preferably 3.3 at. % or more and 6.5 at. % or less, in the case where the element M is composed of Mo.

From the same viewpoint, the amount of M added (y) may be preferably 1 at. % or more and 12 at. % or less, more preferably 1.2 at. % or more and 9.1 at. % or less, particularly preferably 4.1 at. % or more and 7.7 at. % or less, in the case where the element M is composed of W.

Note that, regarding any of the amount of Fe added (x) and the amount of M added (y), the gauge factor Gf tends to decrease when an excessive amount is added. The gauge factor Gf is known to be closely related to the Neel temperature (Tn) of a Cr-based material, and accordingly, it is considered that the decrease in gauge factor Gf be caused by Tn not falling within an appropriate range due to an excessive amount of Fe or M added. Therefore, the total amount (x+y) of the amount of Fe added and the amount of M added may be preferably 11 at. % or less, more preferably 10 at. % or less, particularly preferably 6 at. % or less, although it depends on the type of the constituent of the element M.

The proportion (y/(x+y), unit: %) of the amount of M added (y) to the total amount (x+y) of the amount of Fe added (x) and the amount of M added (y) may be preferably 55% or less, more preferably 50% or less, particularly preferably 40% or less, although it depends on the type of the constituent of the element M.

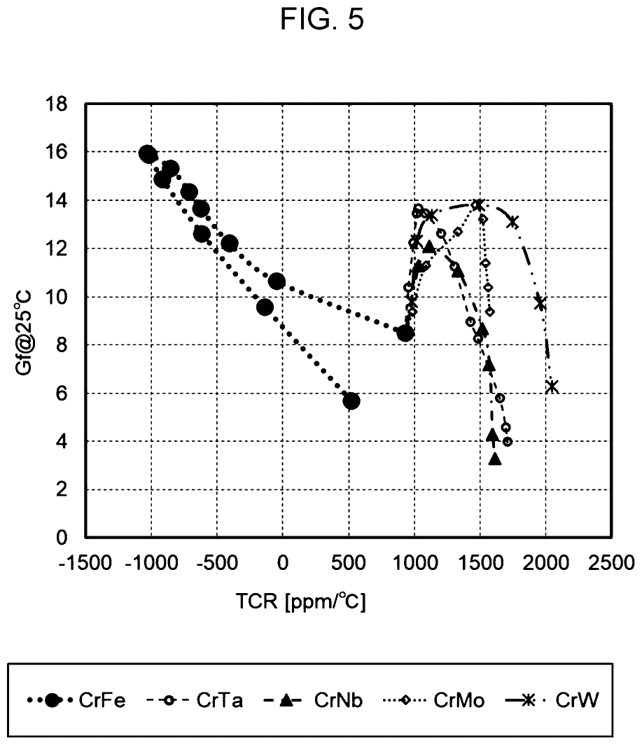

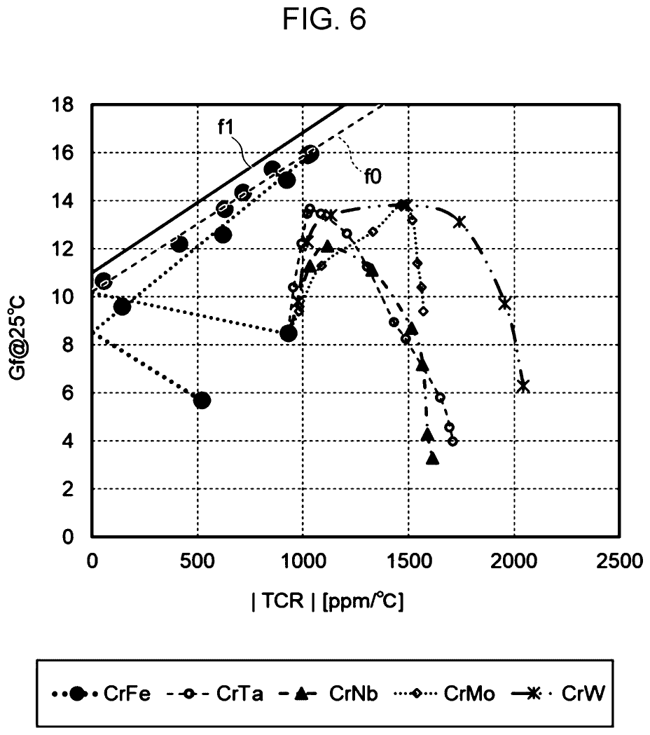

FIG. 5 is a graph representing the relationship between the gauge factor Gf and the temperature coefficient of resistance TCR of the Cr—X alloy. FIG. 6 is a graph converted from that of FIG. 5 so that the horizontal axis shows the absolute value of the temperature coefficient of resistance TCR (unit: ppm/° C.). As shown in FIG. 5, the element Fe greatly differs in behavior from the element M as an element added in the Cr alloy; in particular, the change in temperature coefficient of resistance TCR remarkably differs from those of the elements M. With reference to FIG. 6 with the horizontal axis converted to show the absolute value of the temperature coefficient of resistance TCR for the purpose of more precisely confirming the characteristics of the Cr—Fe alloy, the gauge factor Gf and the absolute value of the temperature coefficient of resistance TCR of the Cr—Fe alloy generally satisfy the following expression (a):

$$G f \leq 0.0 \; 056 \times \vert TCR \vert + 10.21 \qquad ( a )$$

The expression f0 shown by the dashed line in FIG. 6 shows the case where the above expression (a) is an equation, namely an expression obtained by linear approximation of the results shown in Table 1 with the amount of Fe added (x) falling within a range of 1.2 at. % to 5.9 at. %. The Cr—Fe alloy cannot reach the upper left region relative to the expression fo of the graph, that is, the region corresponding to high gauge factors Gf and small absolute values of the temperature coefficient of resistance TCR.

In contrast, the Cr—Fe-M alloy according to the embodiment can reach a region which cannot be reached by the Cr—Fe alloy; that is, the Cr—Fe-M alloy can satisfy the following expression (1):

$$G f > 0.0 \; 056 \times \vert TCR \vert + 10.21 \qquad ( 1 )$$

As shown in the examples described later, the Cr—Fe-M alloy according to the embodiment can reach even the upper left region relative to the expression f1 shown by the solid line in FIG. 6, in one preferable example. That is, in one preferable example, the Cr—Fe-M alloy according to the embodiment can satisfy the following expression (2):

$$G f \geq 0.00 \; 56 \times \vert TCR \vert + 11 \qquad ( 2 )$$

The thickness of the strain resistor 12 of the strain gauge 10 according to the embodiment is not limited. As shown in the examples described later, the thickness of the strain resistor 12 may be positively correlated with the gauge factor Gf and the temperature coefficient of resistance TCR. In this case, a desired gauge factor Gf or temperature coefficient of resistance TCR may be achieved by changing the thickness of the strain resistor 12. That is, the thickness of the strain resistor 12 can be regarded as a factor for adjustment of the characteristics of the strain resistor 12. The thickness of the strain resistor 12 can be adjusted in a range of several tens of nanometers (thin film) to several tens of micrometers (foil) by appropriately setting a production method.

The method of producing the strain resistor 12 according to the embodiment is not limited. The strain resistor 12 is composed of an alloy for strain resistors according to the embodiment as described earlier, and thus can be produced by a known film-forming method such as sputtering, or by machining such as rolling.

In the case of production by sputtering, an alloy having a composition corresponding to a composition of the strain resistor 12 to be produced may be used as a target, or the composition of the strain resistor 12 may be adjusted by coordinating a target composed of a tile-like arrangement of Cr and Fe, and pure metals of M. Alternatively, two or more targets may be simultaneously used in the sputtering while the amount of electricity applied to each target is adjusted, thereby adjusting the composition of the strain resistor 12. Note that, when the strain resistor 12 is formed to have an excessive thickness in the case of a dry-process film formation method such as sputtering, the strain resistor 12 may fail to maintain its shape as a thin film due to an excessive internal stress, depending on the production method. From the viewpoint of ensuring the shape stability of the strain resistor 12, the thickness may be preferably 300 nm or less. On the other hand, when the thickness of the strain resistor 12 is insufficient, the strain resistor 12 may fail to appropriately exert its function due to an insufficient change in resistance arising from strain. From the viewpoint of allowing the strain resistor 12 to achieve its necessary function, the thickness may be preferably 30 nm or more.

In the case of forming a film by sputtering, it is sufficient that a general-purpose sputtering apparatus be used, and an inert element such as argon be employed for an atmosphere. According to the thin-film resistor for strain gauges which is disclosed Japanese Unexamined Patent Application Publication No. 2019-204874, an atmosphere containing oxygen molecules (O₂) and nitrogen molecules (N₂) as reactive gas components is used, and the reactive sputtering is performed while the amounts of oxygen (O) and nitrogen (N) to be contained in the resulting film are controlled, thereby achieving a desired effect (gauge factor of 10 or more, a temperature coefficient of resistance of ±100 [ppm/° C.] or less). However, the reactive sputtering necessitates dedicated equipment (a system of controlling the amount of supplying a reactive gas component, such as a mass flow controller) and, even with use of such dedicated equipment, it is not easy to exactly control the amounts of these elements to be mixed and simultaneously ensure the uniformness of the composition of the film after formed on the substrate. In contrast, the strain resistor 12 according to the embodiment does not necessitate the control of the amount of a reactive gas component to be supplied, so that the strain resistor 12 can be produced by forming an alloy film with use of a general-purpose sputtering apparatus. Therefore, the strain resistor 12 according to the embodiment is excellent in quality stability and also in productivity.

Machining such as rolling may be advantageous from the viewpoint of productivity, such as ease of mass production. In the case of producing the strain resistor 12 by machining, the thickness may be preferably in a range of 1 μm to 10 μm, more preferably in a range of 2 μm to 5 μm, from the viewpoint of ensuring ease of production, handleability, and processing accuracy regarding the thickness.

The above embodiment is described not for limiting the present invention, but for facilitating understanding of the present invention. Therefore, each element disclosed in the above embodiment is intended to encompass all the changes in design and equivalents belonging to the technical scope of the present invention. For example, a case where the element Mis composed of one type of element encompasses a case where another element is present in a degree not substantially affecting the effects of the invention; for instance, a case where another element is mixed inevitably from the viewpoint of industrial production.

The present invention will be specifically described below with reference to the examples.

### EXAMPLES

### Examples 1 and 2

The strain gauge 10 including the strain resistor 12 composed of a Cr—Fe—Ta alloy was produced by sputtering on the substrate 30 composed of a polyimide film. The composition of the Cr—Fe—Ta alloy was as shown in Table 2 (Example 1) and Table 3 (Example 2), where a target value of the amount of Fe added (x) in Example 1 was 5 at. %, whereas a target value of the amount of Fe added (x) in Example 2 was 3 at. %. The thickness of the strain resistor 12 was 100 nm.

TABLE 2

| Amount of | Amount of | Total amount | Ta/total | | TCR | \|TCR\| |
|---|---|---|---|---|---|---|
| Fe added | Ta added | added | amount | | [ppm/ | [ppm/ |
| [at. %] | [at. %] | [at. %] | added | Gf | ° C.] | ° C.] |
| 5.3 | 0.0 | 5.3 | 0% | 15.9 | −1021 | 1021 |
| 5.3 | 0.1 | 5.4 | 2% | 16.0 | −983 | 983 |
| 5.2 | 1.3 | 6.5 | 20% | 16.0 | −494 | 494 |
| 5.2 | 2.0 | 7.2 | 27% | 15.4 | −196 | 196 |
| 5.1 | 2.8 | 8.0 | 36% | 14.1 | 96 | 96 |
| 5.1 | 4.1 | 9.2 | 45% | 11.4 | 562 | 562 |
| 5.0 | 5.2 | 10.2 | 51% | 8.4 | 1003 | 1003 |

TABLE 3

| Amount of | Amount of | Total amount | Ta/total | | TCR | \|TCR\| |
|---|---|---|---|---|---|---|
| Fe added | Ta added | added | amount | | [ppm/ | [ppm/ |
| [at. %] | [at. %] | [at. %] | added | Gf | ° C.] | ° C.] |
| 3.1 | 0.0 | 3.1 | 0% | 13.7 | −629 | 629 |
| 3.1 | 0.1 | 3.2 | 3% | 13.9 | −559 | 559 |
| 3.1 | 0.9 | 4.0 | 23% | 15.1 | −61 | 61 |
| 3.0 | 1.8 | 4.9 | 38% | 13.5 | 256 | 256 |
| 3.0 | 2.8 | 5.9 | 49% | 9.8 | 656 | 656 |
| 3.0 | 3.8 | 6.8 | 56% | 6.4 | 931 | 931 |
| 3.0 | 4.8 | 7.8 | 62% | 3.6 | 1249 | 1249 |

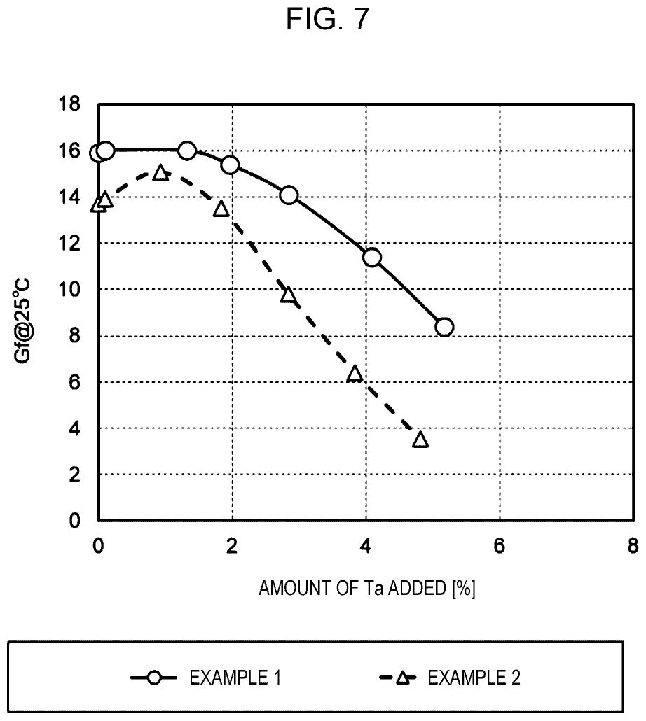

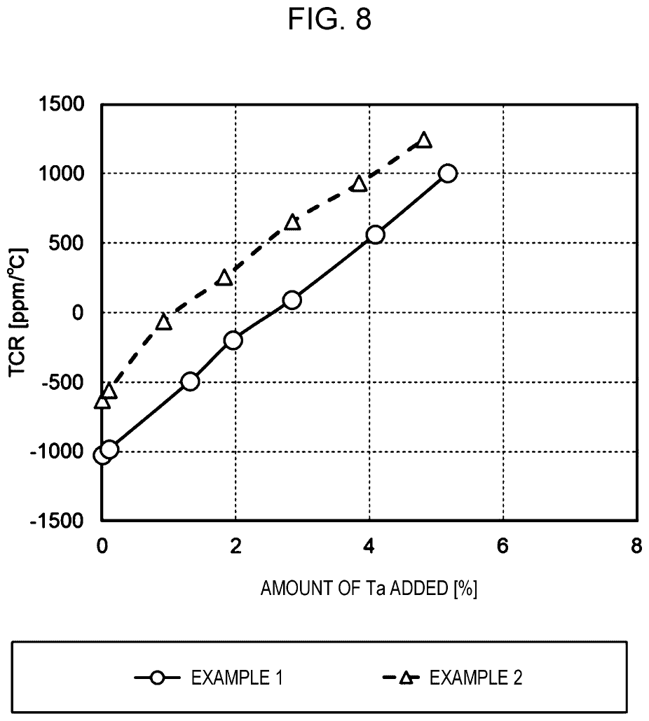

With use of the sensors 100 including the resulting strain gauges 10, the characteristics of the strain gauges 10 were evaluated. The evaluation results are shown in Tables 2 and 3. In addition, FIG. 7 shows the dependency of the gauge factor Gf on the amount of Ta added, and FIG. 8 shows the dependency of the temperature coefficient of resistance TCR on the amount of Ta added, which are based on the results shown in Tables 2 and 3.

Regarding the strain gauges 10 which were produced in Examples 1 and 2 and each included in the corresponding sensor 100, the following matters were confirmed.

(1) In the case where the amount of Fe added (x) was 5.1 at. % or more and 5.3 at. % or less (Example 1), the gauge factor Gf was more than 10 when, according to the tendency shown in FIG. 7, the amount of Ta added (y) was in a range of up to 4.6 at. % and when, according to the measured values shown in Table 2, the amount of Ta added (y) was 4.1 at. % or less, and the temperature coefficient of resistance TCR of the strain gauge 10 was in a range of ±1000 ppm/° C. when, according to the tendency shown in FIG. 8, the amount of Ta added (y) was in a range of 0.1 at. % to 5.1 at. % and when, according to the measured values shown in Table 2, the amount of Ta added (y) was in a range of 0.1 at. % or more and 4.1 at. % or less.

(2) In the case where the amount of Fe added (x) was 3.0 at. % or more and 3.1 at. % or less (Example 2), the gauge factor Gf was more than 10 when, according to the tendency shown in FIG. 7, the amount of Ta added (y) was in a range of up to 2.7 at. % and when, according to the measured values shown in Table 3, the amount of Ta added (y) was 1.8 at. % or less, and the temperature coefficient of resistance TCR was in a range of +1000 ppm/° C. when, according to the tendency shown in FIG. 8, the amount of Ta added (y) was in a range of up to 4.0 at. %, and when, according to the measured values shown in Table 3, the amount of Ta added (y) was 3.8 at. % or less.

### Example 3

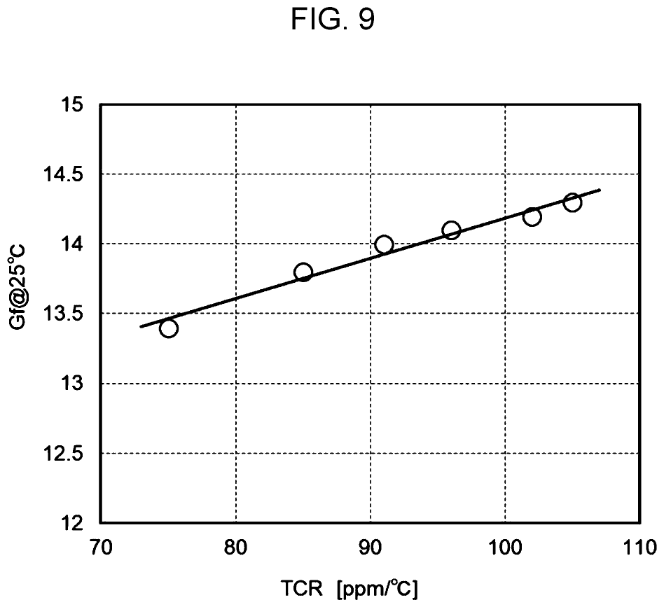

The sensors 100 including the strain resistors 12 composed of Cr—Fe—Ta alloys which had the same composition but had different thicknesses as shown in Table 4 were produced by a production method similar to that in Example 1, and the characteristics of the strain gauges 10 were evaluated. The results are shown in Table 4 and FIG. 9. FIG. 9 is a graph showing the results of Example 3 (changes in film thickness), representing the dependency of the gauge factor Gf on the temperature coefficient of resistance TCR.

TABLE 4

| Amount of | Amount of | Total amount | Film | | |
|---|---|---|---|---|---|
| Fe added | Ta added | added | thickness | | TCR |
| [at. %] | [at. %] | [at. %] | [nm] | Gf | [ppm/° C.] |
| 5.1 | 2.8 | 8.0 | 10.0 | 13.4 | 75.0 |
| | | | 30.0 | 13.8 | 85.0 |
| | | | 50.0 | 14.0 | 91.0 |
| | | | 100.0 | 14.1 | 96.0 |
| | | | 200.0 | 14.2 | 102.0 |
| | | | 300.0 | 14.3 | 105.0 |

It was confirmed that both of the gauge factor Gf and the temperature coefficient of resistance TCR of the strain gauge 10 tend to increase as the thickness (film thickness) of the strain resistor 12 increases, as shown in Table 4 and FIG. 9. The solid line in FIG. 9 represents a result of linear approximation, and the coefficient of determination (R²) was 0.97 (the coefficient of correlation was 0.985). This suggests that, in the case where the composition is fixed, the gauge factor Gf and the temperature coefficient of resistance TCR of the strain gauge 10 can be adjusted by changing the thickness of the strain resistor 12.

### Examples 4 to 6

The strain gauges 10 including the strain resistors 12 containing different types of element M were produced by a production method similar to that in Example 1. Tables 5, 6, and 7 show the case where the element M was composed of Nb (Example 4), the case where the element M was composed of Mo (Example 5), and the case where the element M was composed of W (Example 6), respectively. Note that a target amount of Fe added (x) was 5 at. % in any of the Cr—Fe-M alloys.

TABLE 5

| Amount of | Amount of | Total amount | Nb/total | | TCR | \|TCR\| |
|---|---|---|---|---|---|---|
| Fe added | Nb added | added | amount | | [ppm/ | [ppm/ |
| [at. %] | [at. %] | [at. %] | added | Gf | ° C.] | ° C.] |
| 5.3 | 0.0 | 5.3 | 0% | 15.9 | −1021 | 1021 |
| 5.3 | 0.9 | 6.2 | 15% | 16.0 | −713 | 713 |
| 5.2 | 1.9 | 7.1 | 27% | 14.5 | −302 | 302 |
| 5.1 | 3.0 | 8.1 | 37% | 11.9 | 99 | 99 |
| 5.1 | 3.9 | 9.0 | 43% | 9.6 | 408 | 408 |
| 5.0 | 4.8 | 9.8 | 49% | 6.7 | 771 | 771 |

TABLE 6

| Amount of | Amount of | Total amount | Mo/total | | TCR | \|TCR\| |
|---|---|---|---|---|---|---|
| Fe added | Mo added | added | amount | | [ppm/ | [ppm/ |
| [at. %] | [at. %] | [at. %] | added | Gf | ° C.] | ° C.] |
| 5.3 | 0.0 | 5.3 | 0% | 15.9 | −1021 | 1021 |
| 5.3 | 0.6 | 5.9 | 10% | 16.0 | −889 | 889 |
| 5.2 | 1.6 | 6.8 | 24% | 16.2 | −656 | 656 |
| 5.1 | 3.3 | 8.4 | 39% | 16.8 | −263 | 263 |
| 5.0 | 4.7 | 9.7 | 48% | 14.8 | 89 | 89 |
| 5.0 | 5.6 | 10.6 | 53% | 12.2 | 531 | 531 |
| 5.0 | 6.5 | 11.5 | 57% | 9.1 | 1147 | 1147 |

TABLE 7

| Amount of | Amount of | Total amount | W/total | | TCR | \|TCR\| |
|---|---|---|---|---|---|---|
| Fe added | W added | added | amount | | [ppm/ | [ppm/ |
| [at. %] | [at. %] | [at. %] | added | Gf | ° C.] | ° C.] |
| 5.3 | 0.0 | 5.3 | 0% | 15.9 | −1021 | 1021 |
| 5.3 | 0.8 | 6.1 | 13% | 16.1 | −829 | 829 |
| 5.2 | 1.6 | 6.8 | 23% | 16.3 | −628 | 628 |
| 5.2 | 2.8 | 8.0 | 35% | 16.6 | −282 | 282 |
| 5.1 | 3.7 | 8.8 | 42% | 15.7 | 22 | 22 |
| 5.1 | 4.4 | 9.5 | 46% | 14.7 | 316 | 316 |
| 5.0 | 5.2 | 10.6 | 53% | 12.3 | 673 | 673 |
| 5.0 | 5.9 | 10.9 | 54% | 9.7 | 986 | 986 |

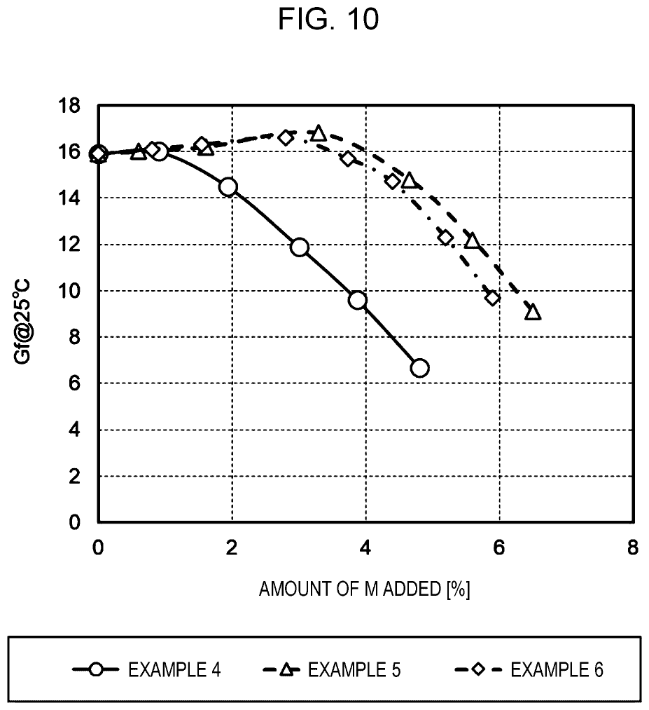

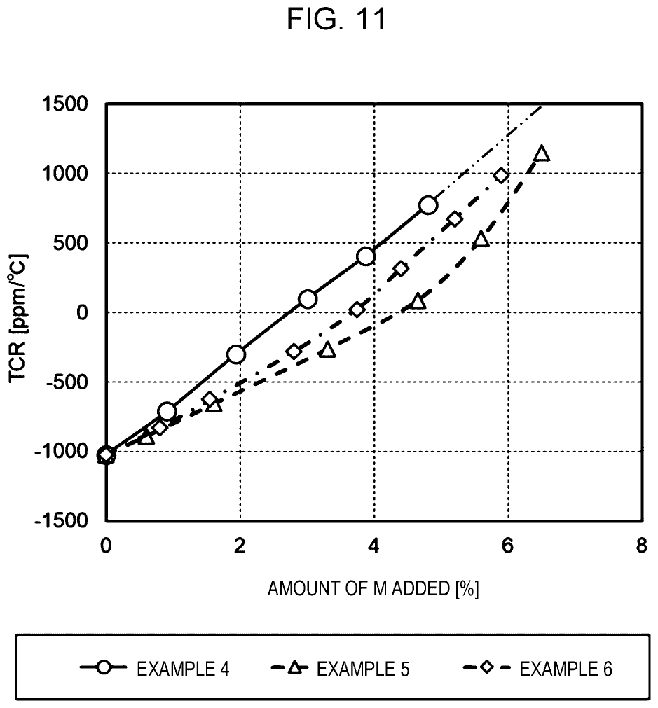

With use of the sensors 100 including the resulting strain gauges 10, the characteristics of the strain gauges 10 were evaluated. The evaluation results are shown in Tables 5 to 7. In addition, FIG. 10 shows the dependency of the gauge factor Gf on the amount of element M added, and FIG. 11 shows the dependency of the temperature coefficient of resistance TCR on the amount of element M added, which are based on the results shown in Tables 5 to 7.

Regarding the strain gauges 10 which were produced in Examples 4 to 6 and each included in the corresponding sensor 100 (the amount of Fe added (x) in the Cr—Fe-M alloy composing the strain resistor 12 was 5.0 at. % or more and 5.3 at. % or less), the following matters were confirmed.

(1) In the case where the element M was Nb (Example 4), the gauge factor Gf was more than 10 when, according to the tendency shown in FIG. 10, the amount of Nb added (y) was in a range of up to 3.8 at. % and when, according to the measured values shown in Table 5, the amount of Nb added (y) was 3.0 at. % or less, and the temperature coefficient of resistance TCR was in a range of +1000 ppm/° C. when, according to the tendency shown in FIG. 11, the amount of Nb added (y) was in a range of up to 5.4 at. % and when, according to the measured values shown in Table 5, the amount of Nb added (y) was 0.9 at. % or more and 4.8 at. % or less.

(2) In the case where the element M was Mo (Example 5), the gauge factor Gf of the strain gauge 10 was more than 10 when, according to the tendency shown in FIG. 10, the amount of Mo added (y) was in a range of up to 6.2 at. % and when, according to the measured values shown in Table 6, the amount of Mo added (y) was 5.6 at. % or less, and the temperature coefficient of resistance TCR of the strain gauge 10 was in a range of ±1000 ppm/° C. when, according to the tendency shown in FIG. 11, the amount of Mo added (y) was in a range of up to 6.2 at. % and when, according to the measured values shown in Table 6, the amount of Mo added (y) was 0.6 at. % or more and 5.6 at. % or less.

(3) In the case where the element M was W (Example 6), the gauge factor Gf of the strain gauge 10 was more than 10 when, according to the tendency shown in FIG. 10, the amount of W added (y) was in a range of up to 5.8 at. % and when, according to the measured values shown in Table 7, the amount of W added (y) was 5.6 at. % or less, and the temperature coefficient of resistance TCR of the strain gauge 10 was in a range of ±1000 ppm/° C. when, according to the tendency shown in FIG. 11, the amount of W added (y) was in a range of up to 6.0 at. % and when, according to the measured values shown in Table 7, the amount of W added (y) was 0.8 at. % or more and 5.9 at. % or less.

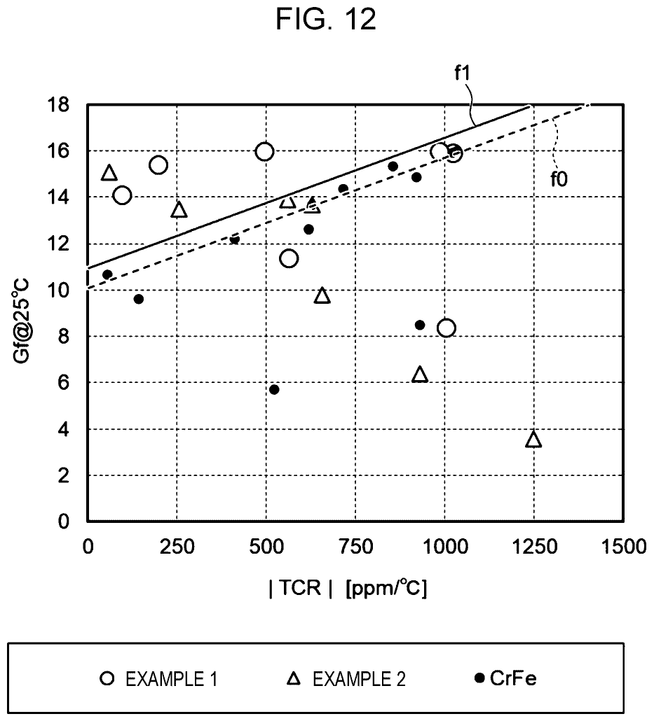

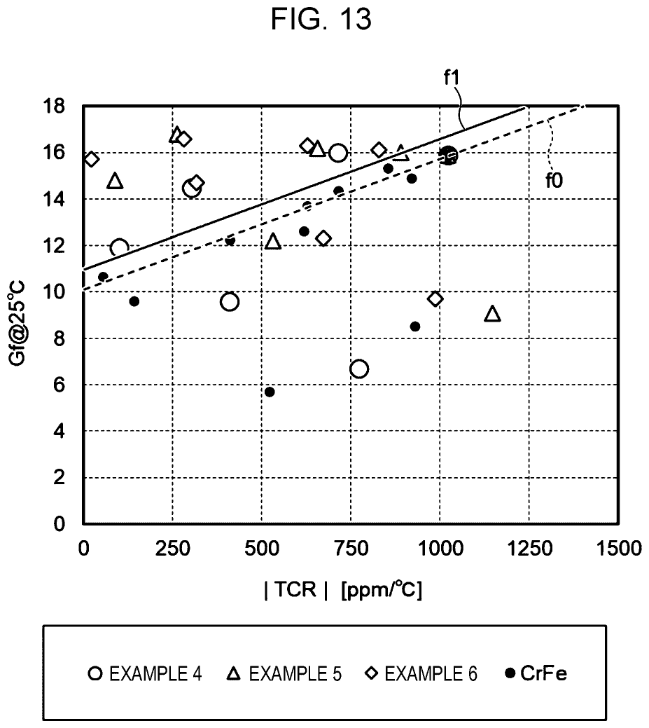

From the viewpoint of more clearly confirming the effect of adding the element M (exhibiting a high gauge factor Gf and not readily affected by temperature changes), the relationship between the gauge factor Gf and the absolute value of the temperature coefficient of resistance TCR shown in FIG. 6 was confirmed also for the cases of Example 1, Example 2, and Examples 4 to 6. FIG. 12 is a graph showing the results of Examples 1 and 2 (influence of change in composition of the Cr—Fe—Ta alloy), representing the dependency of the gauge factor Gf on the absolute value of the temperature coefficient of resistance TCR. FIG. 13 is a graph showing the results of Examples 4 to 6 (types of element M), representing the dependency of the gauge factor Gf on the absolute value of the temperature coefficient of resistance TCR. It was confirmed that, as shown in FIGS. 12 and 13, any example had a result falling within the upper left region relative to the expression f0 in FIGS. 12 and 13, and furthermore, some of the results fell within the upper left region relative to the expression f1.

What is claimed is:

1. An alloy for strain resistors, wherein
the alloy has a composition of Cr_{100-x-y}FeₓM_{y}, where M represents one or two or more elements selected from the group consisting of Nb, Mo, Ta, and W.

2. The alloy for strain resistors according to claim 1, wherein
x represents 0.8 or more and 11.2 or less in terms of atomic percentage.

3. The alloy for strain resistors according to claim 1, wherein
y represents more than 0 and less than or equal to 7.7 in terms of atomic percentage.

4. A strain gauge comprising:
a film-shaped strain resistor having the composition of the alloy for strain resistors according to claim 1.

5. The strain gauge according to claim 4, wherein
the strain resistor has a body-centered cubic (BCC) structure.

6. The strain gauge according to claim 4, wherein
a gauge factor Gf and an absolute value |TCR| of a temperature coefficient of resistance TCR (unit: ppm/° C.) satisfy the following expression (1):
$$G f > 0.00 \; 56 \times \vert TCR \vert + 10.21 . \qquad ( 1 )$$

7. The strain gauge according to claim 4, wherein
a gauge factor Gf and an absolute value |TCR| of a temperature coefficient of resistance TCR (unit: ppm/° C.) satisfy the following expression (2):
$$G f \geq 0.00 \; 56 \times \vert TCR \vert + 11. \qquad ( 2 )$$

8. A sensor comprising:
a substrate; and
the strain gauge according to claim 4 and provided on the substrate, wherein
the strain gauge serves as sensing means.
